(19) United States
(12) Patent Application Publication
(10) Pub. No.: US 2020/0101563 A1
(43) Pub. Date: Apr. 2, 2020

(54) SMOOTHING METHOD FOR ENHANCED WELD SURFACE QUALITY

(71) Applicant: GM GLOBAL TECHNOLOGY OPERATIONS LLC, Detroit, MI (US)

(72) Inventors: Wu Tao, Tianmen (CN); David Yang, Shanghai (CN)

(21) Appl. No.: 16/499,605

(22) PCT Filed: Apr. 3, 2017
(86) PCT No.: PCT/CN2017/079392

§ 371 Date: Sep. 30, 2019

(51) Int. Cl. B23K 26/244; B23K 26/082; B23K 26/22; B23K 26/32

(52) U.S. Cl. CPC B23K 26/244; B23K 26/082; B23K 2103/04; B23K 26/32; B23K 26/22

(57) ABSTRACT

A method for joining together metal workpieces (12, 14, 150) includes advancing a beam spot (44) of a laser beam (24) relative to the top surface (20) of the workpiece stack-up (10) along a primary beam travel pattern (78) to create a molten metal portion (70) within the workpiece stack-up and, thereafter, reducing a power density of the laser beam and moving the beam spot of the laser beam relative to an upper surface (82) of the molten metal portion along a secondary beam travel pattern (84) to introduce heat into the molten metal portion such that the molten metal portion is prevented from fully solidifying and at least an upper region (86) of the molten metal portion that includes the upper surface is maintained in a molten state. The laser beam is then removed from the molten metal portion to allow the molten metal portion to solidify into a laser weld joint (66). The laser weld joint have a smooth top surface.

### TECHNICAL FIELD

The technical field of this disclosure relates generally to a method for joining together two or more overlapping metal workpieces by the practice of laser welding and, more specifically, to a joining method in which laser welding is performed in a way that results in a laser weld joint having a smooth top surface.

### INTRODUCTION

Laser welding is a metal joining process in which a laser beam is directed at an assembly of stacked-up metal workpieces to provide a concentrated heat source capable of effectuating a weld joint between the constituent metal workpieces. In general, complimentary flanges or other bonding regions of two or more metal workpieces are first aligned, fitted, and stacked relative to one another such that their faying surfaces overlap and confront to establish one or more faying interfaces. A laser beam is then directed at an accessible top surface of the workpiece stack-up within a welding region spanned by the overlapping portion of the workpieces. The heat generated from the absorption of energy from the laser beam initiates melting of the metal workpieces and establishes a molten metal weld pool within the workpiece stack-up. The molten metal weld pool penetrates into the stack-up and intersects at least one, and usually all, of the established faying interfaces. And, if the power density of the laser beam is high enough, a keyhole is produced beneath a beam spot of the laser beam within the molten metal weld pool. A keyhole is a column of vaporized metal, which may include plasma, derived from the metal workpieces. The keyhole is an effective absorber of energy from the laser beam, thus allowing for deep and narrow penetration of molten workpiece metal into the stack-up.

The molten metal weld pool and, if present, the keyhole, are created in very short order once the laser beam impinges the top surface of the workpiece stack-up. After the metal workpieces are initially melted, the beam spot of the laser beam may be advanced relative to the top surface of the workpiece stack-up, which has conventionally involved moving the laser beam along a beam travel pattern of a relatively simple or complex geometrical profile as projected onto the top surface of the stack-up. As the laser beam is advanced along the top surface of the stack-up, molten workpiece material from the weld pool flows around and behind the advancing beam spot within the workpiece stack-up. The transmission of the laser beam at the top surface of the workpiece stack-up is eventually ceased once the laser beam has finished tracking the beam travel pattern, at which time the keyhole collapses, if present, and the penetrating molten workpiece material created within the stack-up cools down and solidifies. The collective resolidified composite workpiece material obtained by operation of the laser beam constitutes a laser weld joint that autogenously fusion welds the overlapping metal workpieces together.

Many industries use laser welding as part of their manufacturing practice including the automotive, aviation, maritime, railway, and building construction industries, among others. Laser welding is an attractive joining process because it requires only single side access, can be practiced with reduced flange widths, and results in a relatively small heat-affected zone within the stack-up assembly that minimizes thermal distortion in the metal workpieces. In the automotive industry, for example, laser welding can be used to join together metal workpieces during the manufacture of the body-in-white (BIW) as well as finished hang-on parts that are installed on the BIW prior to painting. Some specific instances where laser welding may be used include the construction and attachment of load-bearing body structures within the BIW such as rail structures, rockers, A-, B-, and C-pillars, and underbody cross-members. Other specific instances where laser welding may also be used include non-load-bearing attachments within the BIW, such as the attachment of a roof to a side panel, and to join overlying flanges encountered in the construction of the doors, hood, and trunk.

The practice of laser welding can present challenges for certain types of metal workpieces. For example, when the metal workpieces included in the workpiece stack-up are steel workpieces, aluminum workpieces, or magnesium workpieces, the turbulence produced in the molten workpiece metal during advancement of the laser beam and the tendency for gasses to be trapped within the molten workpiece material, which leads to porosity defects when the molten workpiece material cools and solidifies, can cause a disturbed and roughened top surface in the ultimately-formed laser weld joint. A coarse top surface of the laser weld joint not only gives the appearance of a poor-quality weld joint, even in instances where the weld joint is structurally sound and has satisfactory mechanical properties, but it can also create points of residual stress concentration that are susceptible to cracking and, in particular, stress corrosion cracking when the joint is subjected to a tensile load in a corrosive environment. A coarse top surface of the laser weld joint may also damage seal strips that are may be applied over the joint when the joint is located on a vehicle door or along a door or window opening of the BIW.

The occurrence of a coarse top surface of a laser weld joint is particularly common when the metal workpieces being laser welded together are composed of aluminum. In addition to the high solubility of hydrogen gas in molten aluminum and the turbulence produced by laser beam, molten aluminum has a relatively low surface tension and the surrounding solid aluminum material has a relatively high thermal conductivity. The combination of these characteristics of aluminum generally contributes to tendency of a coarse top surface to materialize in the laser weld joint as there is often insufficient time for the surface of molten aluminum to naturally settle and flatten out due to the fast rate at which the molten aluminum cools and solidifies, especially when the molten aluminum is stirred by the advancement of the laser beam along its predefined beam travel pattern. Similar dynamics may arise when the metal workpieces being laser welded together are composed of magnesium. This disclosure describes a method for joining together metal workpieces in a way that ensures the resultant laser weld joint has a smooth top surface regardless of whether the workpiece stack-up includes steel workpieces, aluminum workpieces, or magnesium workpieces.

### SUMMARY OF THE DISCLOSURE

An embodiment of a method of joining together metal workpieces by the practice of laser welding may include several steps. First, a workpiece stack-up may be assembled that that includes two or more metal workpieces that overlap to define a welding zone. The welding zone of the workpiece stack-up has a top surface and a bottom surface and further establishes a faying interface between each pair of adjacent metal workpieces included in the workpiece stack-up. Second, a beam spot of a laser beam is advanced relative to the top surface of the workpiece stack-up along a primary beam travel pattern to create a molten metal portion that penetrates into the workpiece stack-up from the top surface of the stack-up towards the bottom surface of the stack-up and intersects the at least one faying interface established between the top and bottom surfaces of the workpiece stack-up. Third, a power density of the laser beam is reduced after creation of the molten metal portion and the beam spot of the laser beam is moved relative to an upper surface of the molten metal portion along a secondary beam travel pattern. Such movement of the laser beam introduces heat into the molten metal portion such that the molten metal portion is prevented from fully solidifying and at least an upper region of the molten metal portion that includes the upper surface is maintained in a molten state. And fourth, the laser beam is eventually removed from the molten metal portion to allow the molten metal portion to solidify into a laser weld joint comprised of resolidified composite workpiece material derived from each of the metal workpieces penetrated by the molten metal portion.

The workpiece stack-up of the method of this particular embodiment may include two or three overlapping metal workpieces. In one implementation of the method, each of the two or three overlapping metal workpieces is a steel workpiece. In another implementation of the method, each of the overlapping metal workpieces is an aluminum workpiece, or each of the overlapping metal workpieces is a magnesium workpiece. Moreover, the laser weld joint formed in the workpiece stack-up may be a laser spot weld joint or a laser seam weld joint, regardless of the number of overlapping metal workpieces included in the workpiece stack-up or the composition of those metal workpieces. And regardless of whether the laser weld joint is a spot weld joint or a seam weld joint, or some other type of joint, it may have a top surface located adjacent to the top surface of the workpiece stack-up that is considered smooth due to having a surface roughness (Ra) that ranges from 12.5 μm to 0.4 μm.

The laser beam used during practices of this embodiment of the disclosed method may be a solid-state laser beam. Such a laser beam may be advanced relative to the top surface of the workpiece stack-up along the primary beam travel pattern (to create the molten metal portion) and subsequently moved relative to the upper surface of the molten metal portion along the secondary beam travel pattern (to introduce heat into the molten metal portion) by a remote laser welding apparatus. In so doing, for example, the laser beam may be advanced relative to the top surface of the workpiece along the primary beam travel pattern at a travel speed that ranges from 1 m/min to 120 m/min while a power level of the laser beam ranges from 2 kW to 10 kW and a focal position of the laser beam is between −20 mm and +20 mm And, thereafter, the laser beam may be moved relative to the upper surface of the molten metal portion along the secondary beam travel pattern at a travel speed that ranges from 10 m/min to 120 m/min while a power level of the laser beam ranges from 2 kW to 10 kW and a focal position of the laser beam is between −50 mm and −10 mm or +10 mm and +50 mm.

Other aspects of the aforementioned embodiment of the disclosed method may also be further defined. For example, the act of reducing the power density of the laser beam may comprise defocusing the laser beam to increase a focal distance of the laser beam, reducing a power level of the laser beam, or defocusing the laser beam to increase a focal distance of the laser beam and reducing a power level of the laser beam. Additionally, the creation of the molten metal portion may be carried out in keyhole welding mode, although conduction welding mode may still be suitable in some or all conditions. This involves producing a keyhole beneath the beam spot of the laser beam. The keyhole is surrounded by the molten metal weld pool. As such, the keyhole is translated within the workpiece stack-up during advancement of the beam spot of the laser beam along the primary beam travel pattern.

Another embodiment of a method of joining together metal workpieces by the practice of laser welding may include several steps. First, a workpiece stack-up is provided that includes two or more metal workpieces that overlap to define a welding zone. The welding zone of the workpiece stack-up has a top surface and a bottom surface and further establishes a faying interface between each pair of adjacent metal workpieces included in the workpiece stack-up. All of the two or more metal workpieces in the workpiece stack-up are steel workpieces, aluminum workpieces, or magnesium workpieces. Second, a laser beam, which has a power density, is directed at the top surface of the workpiece stack-up to produce a keyhole within the workpiece stack-up that is surrounded by a molten metal weld pool. Third, a beam spot of the laser beam is advanced relative to the top surface of the workpiece stack-up along a primary beam travel pattern to create a molten metal portion that penetrates into the workpiece stack-up from the top surface of the stack-up towards the bottom surface of the stack-up and intersects the at least one faying interface established between the top and bottom surfaces of the workpiece stack-up. During such advancement along the primary beam travel pattern, the power density of the laser beam ranges from 0.7 MW/cm² to 4 MW/cm². Fourth, the power density of the laser beam is reduced to between 0.01 MW/cm² and 0.5 MW/cm² after creation of the molten metal portion. Fifth, the beam spot of the laser beam is moved relative to an upper surface of the molten metal portion along a secondary beam travel pattern. Such movement of the laser beam introduces heat into the molten metal portion such that the molten metal portion is prevented from fully solidifying and at least an upper region of the molten metal portion that includes the upper surface is maintained in a molten state. And sixth, the transmission of the laser beam is ceased to allow the molten metal portion to fully solidify into a laser weld joint comprised of resolidified composite workpiece material derived from each of the metal workpieces penetrated by the molten metal portion.

The aforementioned embodiment of the disclosed method may be further defined. The workpiece stack-up may, for example, include two or three overlapping metal workpieces, all of which are steel workpieces, aluminum workpieces, or magnesium workpieces. In another implementation, the top surface of the laser weld joint, which is located adjacent to the top surface of the workpiece stack-up, may have a surface roughness (Ra) that ranges from 12.5 μm to 0.4 μm, although situations may certainly exist where the surface roughness measurements of the top surface of the laser weld joint falls outside of that ranges. Still further, the act of reducing the power density of the laser beam may comprise defocusing the laser beam to increase a focal distance of the laser beam, reducing a power level of the laser beam, or defocusing the laser beam to increase a focal distance of the laser beam and reducing a power level of the laser beam.

The laser beam used during practices of this embodiment of the disclosed method may be a solid-state laser beam. Such a laser beam may be advanced relative to the top surface of the workpiece stack-up along the primary beam travel pattern (to create the molten metal portion) and subsequently moved relative to the upper surface of the molten metal portion along the secondary beam travel pattern (to introduce heat into the molten metal portion) by a remote laser welding apparatus. In so doing, for example, the laser beam may be advanced relative to the top surface of the workpiece along the primary beam travel pattern at a travel speed that ranges from 1 m/min to 120 m/min while a power level of the laser beam ranges from 2 kW to 10 kW and a focal position of the laser beam is between −20 mm and +20 mm. And, thereafter, the laser beam may be moved relative to the upper surface of the molten metal portion along the secondary beam travel pattern at a travel speed that ranges from 10 m/min to 120 m/min while a power level of the laser beam ranges from 2 kW to 10 kW and a focal position of the laser beam is between −50 mm and −10 mm or +10 mm and +50 mm.

Still another embodiment of a method of joining together metal workpieces may include several steps. First, a workpiece stack-up is provided that includes two or more metal workpieces that overlap to define a welding zone. The welding zone of the workpiece stack-up has a top surface and a bottom surface and further establishes a faying interface between each pair of adjacent metal workpieces includes in the stack-up. All of the two or more metal workpieces in the workpiece stack-up are steel workpieces, aluminum workpieces, or magnesium workpieces. Second, a scanning optic laser head of a remote laser welding apparatus is operated to direct a laser beam at the top surface of the workpiece stack-up and, additionally, to advance a beam spot of the laser beam relative to the top surface of the stack-up within the welding zone along a primary beam travel pattern to translate a keyhole along a corresponding route within the workpiece stack-up. Such advancement of the beam spot of the laser beam creates a molten metal portion that penetrates into the workpiece stack-up and intersects each faying interface established between the top and bottom surfaces of the workpiece stack-up. Third, the scanning optic laser head of the remote laser welding apparatus is operated to reduce a power density of the laser beam and to further move the beam spot of the laser beam along an upper portion of the molten metal portion along a secondary beam travel pattern to introduce heat into the molten metal portion such that at least an upper region of the molten metal portion that includes the upper surface is maintained in a molten state. And fourth, the laser beam is removed from the molten metal portion to allow the molten metal portion to into a weld joint that fusion welds the two or three metal workpieces together. The laser weld joint has a smooth top surface, which is adjacent to the top surface of the workpiece stack-up, that has a surface roughness (Ra) that ranges from 12.5 μM to 0.4 μM.

Other aspects of the aforementioned embodiment of the disclosed method may also be further defined. For example, the act of reducing the power density of the laser beam may comprise defocusing the laser beam to increase a focal distance of the laser beam, reducing a power level of the laser beam, or defocusing the laser beam to increase a focal distance of the laser beam and reducing a power level of the laser beam. As another example, the movement of the laser beam relative to the upper surface of the molten metal portion and along the secondary beam travel pattern may be carried out within prescribed ranges of certain beam parameters. In that regard, the laser beam may be moved relative to the upper surface of the molten metal portion along the secondary beam travel pattern at a travel speed that ranges from 10 m/min to 120 m/min while a power level of the laser beam ranges from 2 kW to 10 kW and a focal position of the laser beam is between −50 mm and −10 mm or +10 mm and +50 mm.

### BRIEF DESCRIPTION OF THE DRAWINGS

FIG. 1 is a general illustration of a workpiece stack-up that includes overlapping metal workpieces along with a remote laser welding apparatus that can carry out the disclosed method of joining together the overlapping metal workpieces;

FIG. 2 is a magnified representative view of the laser beam depicted in FIG. 1 showing a focal point and a longitudinal axis of the laser beam that is employed in an embodiment of the disclosed method;

FIG. 3 is a magnified plan view of a workpiece stack-up shown in FIG. 1 during creation of a molten metal portion within the stack-up according to one aspect of the present disclosure in which a laser beam is directed towards the workpiece stack-up and advanced relative to a top surface of the stack-up along a primary beam travel pattern by a scanning optic laser head of a remote laser welding apparatus;

FIG. 4 is a partial cross-sectional view of the workpiece stack-up shown in FIG. 3 during creation of a molten metal portion within the stack-up according to one aspect of the present disclosure;

FIG. 5 is a generalized cross-sectional view of the workpiece stack-up including the molten metal portion that has been created by advancing the beam spot of the laser beam realtive to the top surface of the workpiece stack-up along a primary beam travel pattern;

FIG. 6 is a partial cross-sectional view of another embodiment of the workpiece stack-up shown in FIG. 1 during creation of a molten metal portion within the stack-up, which is taken from the same perspective as FIG. 4, although in this illustration the workpiece stack-up includes three overlapping metal workpieces instead of two as shown in FIG. 4;

FIG. 7 is a generalized cross-sectional view of the molten metal portion, which was previously produced, along with the laser beam which, after having its power density reduced, is being moved relative to the upper surface of the molten metal portion to prevent the molten metal portion from fully solidifying and to maintain at least an upper region of the molten metal portion that includes the upper surface in a molten state;

FIG. 8 is an elevated perspective view of a workpiece stack-up that shows a molten metal portion formed by the laser beam within overlapping metal workpieces along with a projection of a secondary beam travel pattern that, according to one aspect of the present disclosure, may be traced by the laser beam in order introduce heat into the molten metal portion such that the molten metal portion is prevented from fully solidifying and at least an upper region of the molten metal portion that includes the upper surface is maintained in a molten state, and wherein the secondary beam travel pattern shown here is comprised of a single continuous sinusoidal weld path;

FIG. 9 is an elevated perspective view of a workpiece stack-up that shows a molten metal portion formed by the laser beam within overlapping metal workpieces along with a projection of a secondary beam travel pattern that, according to one aspect of the present disclosure, may be traced by the laser beam in order introduce heat into the molten metal portion such that the molten metal portion is prevented from fully solidifying and at least an upper region of the molten metal portion that includes the upper surface is maintained in a molten state, and wherein the beam travel pattern shown here is comprised of a single spiral weld path; and

FIG. 10 is a generalized cross-sectional view of a laser weld joint after the molten metal portion has been allowed to solidify following removal of the laser beam from the molten metal portion.

### DETAILED DESCRIPTION

The disclosed method of joining together two or more stacked-up metal workpieces by way of laser welding involves, first, creating a molten metal portion within the workpiece stack-up by directing a laser beam at a top surface of the stack-up and then advancing a beam spot of the laser beam relative to the top surface along a primary beam travel pattern. The molten metal portion may thus take on a variety of shapes and sizes depending on the geometry of the primary beam travel pattern and its projected size onto the top surface, and it generally penetrates into the workpiece stack-up from the top surface of the stack-up towards the bottom surface of the stack-up and intersects at least one faying interface. After the molten metal portion is formed, the power density of the laser beam is reduced and the beam spot of the laser beam is moved relative to an upper surface of the molten metal material along a secondary beam travel pattern to introduce heat into the molten metal portion and prevent it from fully solidifying. In this way, at least an upper region of the molten metal portion, which includes the upper surface of the molten metal portion, is maintained in a molten state for an extended period of time. Eventually, the laser beam is removed from the molten metal portion to allow the molten metal portion to solidify into a laser weld joint.

Maintaining at least the upper region of the molten metal portion—and, preferably, the entire molten metal portion—in a molten state for an extended period of time, as opposed to letting it rapidly cool and solidify once created, is believed to contribute to a more satisfactory weld joint structure. Indeed, by using the laser beam at a reduced power density to keep at least the upper region of the molten portion in a molten state, thus delaying full solidification of the molten metal portion, sufficient time can be made available to allow the upper surface of the molten metal portion to settle and flatten out as aided by the inherent surface tension of the molten metal. The result of such a practice is a laser weld joint having a top surface, which is essentially the exposed surface of the laser joint located adjacent to a top surface of the workpiece stack-up, that is smooth. In many instances, the smooth top surface of the laser weld joint has a surface roughness (Ra) that ranges from 12.5 μM to 0.4 μM. By providing the laser weld joint with a smooth top surface, residual stress concentration points that may be prone to crack initiation and propagation are removed and the laser weld joint is less liable to damage seal strips that may be applied over in close proximity to the joint. The smooth top surface also gives the laser weld joint a more aesthetically pleasing appearance.

The formation of the laser weld joint with its smooth top surface can be performed by any type of laser welding apparatus such as, for example, a remote laser welding apparatus or a conventional laser welding apparatus such as, for example, an apparatus in which a fixed laser head is carried by a high-speed CNC machine. The laser beam employed to form the laser weld joint according to practices of the disclose method be a solid-state laser beam or a gas laser beam depending on the characteristics of the metal workpieces being joined and the laser welding mode (conduction welding mode or keyhole welding mode) desired to be practiced. Some notable solid-state lasers that may be used are a fiber laser, a disk laser, a direct diode laser, and a Nd:YAG laser, and a notable gas laser that may be used is a CO₂ laser, although other types of lasers may certainly be used. In a preferred implementation of the disclosed method, which is described below in more detail, a remote laser welding apparatus is employed to form the laser weld joint with its smooth top surface including the acts of creating the molten metal portion within the workpiece stack-up and subsequently preventing full solidification of the molten metal portion until the upper surface of the molten metal portion has time to settle and flatten out.

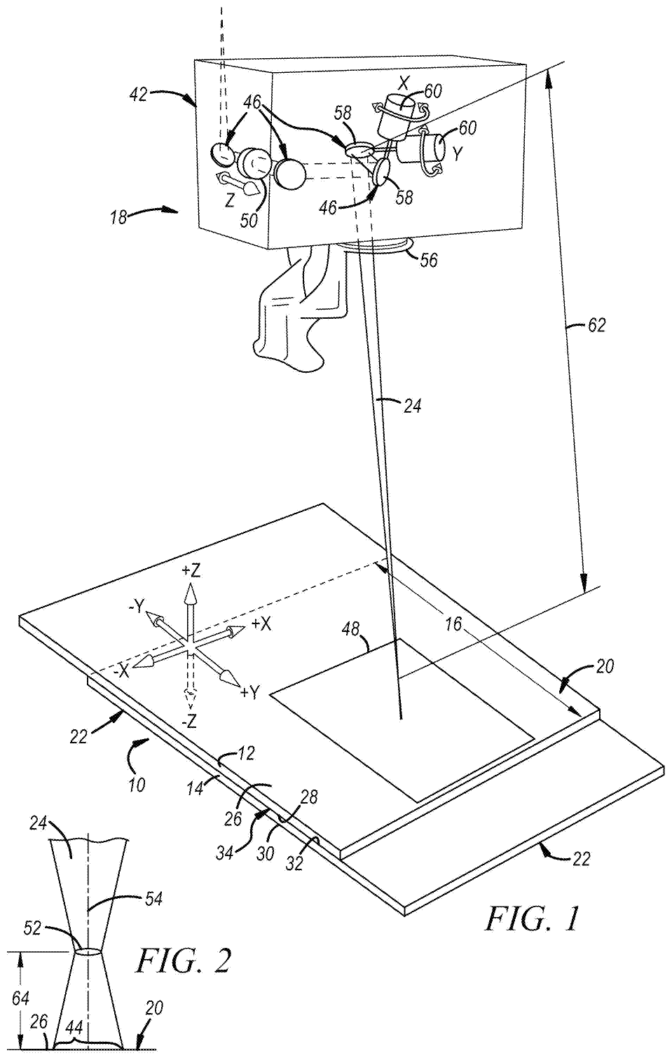

The disclosed method of joining together two or more metal workpieces by way of laser welding can be performed on a variety of workpiece stack-up configurations. For example, the disclosed method may be used in conjunction with a “2T” workpiece stack-up (FIGS. 1 and 4-5) that includes two overlapping metal workpieces, or it may be used in conjunction with a “3T” workpiece stack-up (FIG. 6) that includes three overlapping metal workpieces. Still further, in some instances, the disclosed method may be used in conjunction with a “4T” workpiece stack-up (not shown) that includes four overlapping metal workpieces. The two or more metal workpieces included in the workpiece stack-up may all be steel workpieces, aluminum workpieces, or magnesium workpieces, and they need not necessarily have the same composition or have the same thickness as the others in the stack-up. The disclosed method is carried out in essentially the same way to achieve the same results regardless of whether the workpiece stack-up includes two overlapping metal workpieces or more than two overlapping metal workpieces. Any differences in workpiece stack-up configurations can be easily accommodated by adjusting the characteristics of the operating laser beam.

Referring now generally to FIG. 1, a workpiece stack-up 10 is shown in which the stack-up 10 includes at least a first metal workpiece 12 and a second metal workpiece 14 that overlap to define a welding zone 16. A remote laser welding apparatus 18 that can perform the disclosed method is also shown. Within the confines of the welding zone 16, the first and second metal workpieces 12, 14 provide a top surface 20 and a bottom surface 22, respectively, of the workpiece stack-up 10. The top surface 20 of the workpiece stack-up 10 is made available to the remote laser welding apparatus 18 and is accessible by a laser beam 24 emanating from the remote laser welding apparatus 18. And since only single side access is needed to conduct laser welding, there is no need for the bottom surface 22 of the workpiece stack-up 10 to be made accessible in the same way. The terms “top surface” and “bottom surface” as used herein are relative designations that identify the surface of the stack-up 10 (top surface) that is more proximate to and facing the remote laser welding apparatus 18 and the surface of the stack-up 10 (bottom surface) that is facing in the opposite direction.

The workpiece stack-up 10 may include only the first and second metal workpieces 12, 14, as shown in FIGS. 1 and 4-5. Under these circumstances, and as shown best in FIG. 4, the first metal workpiece 12 includes an exterior outer surface 26 and a first faying surface 28, and the second metal workpiece 14 includes an exterior outer surface 30 and a second faying surface 32. The exterior outer surface 26 of the first metal workpiece 12 provides the top surface 20 of the workpiece stack-up 10 and the exterior outer surface 30 of the second metal workpiece 14 provides the oppositely-facing bottom surface 22 of the stack-up 10. And, since the two metal workpieces 12, 14 are the only workpieces present in the workpiece stack-up 10, the first and second faying surfaces 28, 32 of the first and second metal workpieces 12, 14 overlap and confront within the welding zone 16 to establish a faying interface 34. In other embodiments, one of which is described below in connection with FIG. 6, the workpiece stack-up 10 may include an additional third metal workpiece disposed between the first and second metal workpieces 12, 14 to provide the stack-up 10 with three metal workpieces instead of two.

The term “faying interface” is used broadly in the present disclosure and is intended to encompass a wide range of overlapping relationships between the confronting first and second faying surfaces 28, 32 of the first and second metal workpieces 12, 14 that can accommodate the practice of laser welding. For instance, the faying surfaces 28, 32 may establish the faying interface 34 by being in direct or indirect contact. The faying surfaces 28, 32 are in direct contact with each other when they physically abut and are not separated by a discrete intervening material layer or gaps that fall outside of normal assembly tolerance ranges. The faying surfaces 28, 32 are in indirect contact when they are separated by a discrete intervening material layer such as a sealer or adhesive—and thus do not experience the type of interfacial abutment that typifies direct contact—yet are in close enough proximity that laser welding can be practiced. As another example, the faying surfaces 28, 32 may establish the faying interface 34 by being separated by imposed gaps. Such gaps may be imposed between the faying surfaces 28, 32 by creating protruding features on one or both of the faying surfaces 28, 32 through laser scoring, mechanical dimpling, or otherwise. The protruding features maintain intermittent contact points between the faying surfaces 28, 32 that keep the surfaces 28, 32 spaced apart outside of and around the contact points by up to 1.0 mm.

Referring still to FIG. 4, the first metal workpiece 12 includes a first base metal substrate 36 and the second metal workpiece 14 includes a second base metal substrate 38. The first and second base metal substrates 36, 38 may all be composed of steel, aluminum, or magnesium; that is, the first and second base metal substrates 36, 38 are both composed of steel, both composed of aluminum, or both composed of magnesium. At least one of the first or second base metal substrates 36, 38 may include a surface coating 40. The surface coating(s) 40 may be employed on one or both of the base metal substrates 36, 38 for various reasons including corrosion protection, strength enhancement, and/or to improve processing, among other reasons, and the composition of the coating(s) 40 is based largely on the composition of the underlying base metal substrates 36, 38. Taking into the account the thickness of the base metal substrates 36, 38 and their optional surface coatings 40, each of a thickness 121 of the first metal workpiece 12 and a thickness 141 of the second metal workpiece 14 preferably ranges from 0.4 mm to 6.0 mm at least within the welding zone 16. The thicknesses 121, 141 of the first and second metal workpieces 12, 14 may be the same or different from each other.

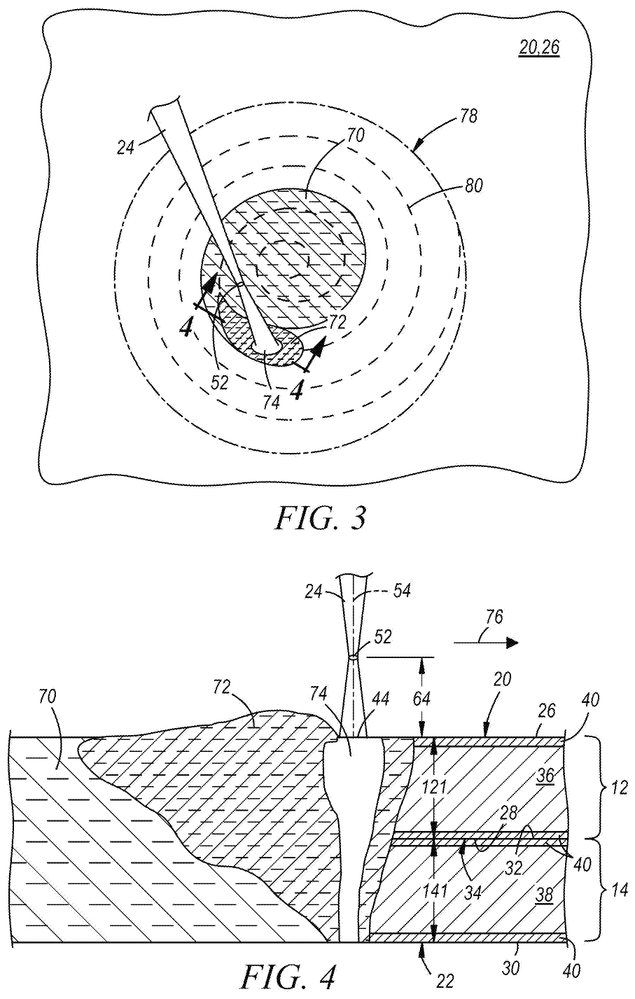

Each of the first and second base metal substrates 36, 38 may be coated with a surface coating 40 as shown here in FIG. 3. The surface coatings 40, in turn, provide the metal workpieces 12, 14 with their respective exterior outer surfaces 26, 30 and their respective faying surfaces 28, 32. In another embodiment, only the first base metal substrate 36 includes a surface coating 40 while the second metal substrate 36 is uncoated or bare. Under these circumstances, the surface coating 40 covering the first base metal substrate 36 provides the first metal workpiece 12 with its exterior outer and faying surfaces 26, 28, while the second base metal substrate 38 provides the second metal workpiece 14 with its exterior outer and faying surfaces 30, 32. In yet another embodiment, only the second base metal substrate 38 includes the surface coating 40 while the first base metal substrate 36 is uncoated or bare. Consequently, in this case, the first base metal substrate 36 provides the first metal workpiece 12 with its exterior outer and faying surfaces 26, 28, while the surface coating 40 covering the second base metal substrate 38 provides the second metal workpiece 14 with its exterior outer and faying surfaces 30, 32.

The base metal substrates 36, 38 may assume any of a wide variety of metal forms and compositions that fall within the broadly-recited base metal groups of steel, aluminum, and magnesium. For instance, if composed of steel, each of the base metal substrates 36, 38 (referred to for the moment as the first and second base steel substrates 36, 38) may be separately composed of any of a wide variety of steels including a low carbon (mild) steel, interstitial-free (IF) steel, bake-hardenable steel, high-strength low-alloy (HSLA) steel, dual-phase (DP) steel, complex-phase (CP) steel, martensitic (MART) steel, transformation induced plasticity (TRIP) steel, twining induced plasticity (TWIP) steel, and boron steel such as when the steel workpiece(s) 12, 14 include press-hardened steel (PHS). Moreover, each of the first and second base steel substrates 36, 38 may have been treated to obtain a particular set of mechanical properties, including being subjected to heat-treatment processes such as annealing, quenching, and/or tempering. The first and second base steel substrates 36, 38 may be hot or cold rolled to their final thicknesses and may be pre-fabricated to have a particular profile suitable for assembly into the workpiece stack-up 10.

The surface coating 40 present on one or both of the base steel substrates 36, 38 is preferably comprised of a zinc-based material or an aluminum-based material. Some examples of a zinc-based material include zinc or a zinc alloy such as a zinc-nickel alloy or a zinc-iron alloy. One particularly preferred zinc-iron alloy that may be employed has a bulk average composition that includes 8 wt % to 12 wt % iron and 0.5 wt % to 4 wt % aluminum with the balance (in wt %) being zinc. A coating of a zinc-based material may be applied by hot-dip galvanizing (hot-dip galvanized zinc coating), electrogalvanizing (electrogalvanized zinc coating), or galvannealing (galvanneal zinc-iron alloy), typically to a thickness of between 2 μm to 50 μm, although other procedures and thicknesses of the attained coating(s) may be employed. Some examples of a suitable aluminum-based material include aluminum, an aluminum-silicon alloy, an aluminum-zinc alloy, and an aluminum-magnesium alloy. A coating of an aluminum-based material may be applied by dip coating, typically to a thickness of 2 μm to 30 μm, although other coating procedures and thicknesses of the attained coating(s) may be employed. Taking into the account the thicknesses of the base steel substrates 36, 38 and their surface coating(s) 40, if present, the overall thickness of each of the first and second steel workpieces 12, 14 preferably ranges from 0.4 mm to 4.0 mm, or more narrowly from 0.5 mm to 2.0 mm, at least within the welding zone 16.

If the first and second base metal substrates 36, 38 are composed of aluminum, each of the base metal substrates 36, 38 (referred to for the moment as the first and second base aluminum substrates 36, 38) may be separately composed of unalloyed aluminum or an aluminum alloy that includes at least 85 wt % aluminum. Some notable aluminum alloys that may constitute the first and/or second base aluminum substrates 36, 38 are an aluminum-magnesium alloy, an aluminum-silicon alloy, an aluminum-magnesium-silicon alloy, or an aluminum-zinc alloy. Additionally, each of the base aluminum substrates 36, 38 may be separately provided in wrought or cast form. For example, each of the base aluminum substrates 36, 38 may be composed of a 4xxx, 5xxx, 6xxx, or 7xxx series wrought aluminum alloy sheet layer, extrusion, forging, or other worked article, or a 4xx.x, 5xx.x, or 7xx.x series aluminum alloy casting. Some more specific kinds of aluminum alloys that can be used as the first and/or second base aluminum substrates 36, 38 include AA5182 and AA5754 aluminum-magnesium alloy, AA6011 and AA6022 aluminum-magnesium-silicon alloy, AA7003 and AA7055 aluminum-zinc alloy, and Al-10Si—Mg aluminum die casting alloy. The first and/or second base aluminum substrates 36, 38 may be employed in a variety of tempers including annealed (O), strain hardened (H), and solution heat treated (T).

The surface coating 40 present on one or both of the base aluminum substrates 36, 38 may be a native refractory oxide coating comprised of aluminum oxide compounds that forms passively when fresh aluminum from the base aluminum substrate 36, 38 is exposed to atmospheric air or some other oxygen-containing medium. The surface coating 40 may also be a metallic coating comprised of zinc or tin, or it may be a metal oxide conversion coating comprised of oxides of titanium, zirconium, chromium, or silicon as disclosed in U.S. Patent Application No. US2014/0360986. A typical thickness of the surface coating 40, if present, lies anywhere from 1 nm to 10 μm depending on the composition of the coating 40 and the manner in which the coating 40 is derived, although other thicknesses may be employed. Passively formed refractory oxide coatings, for example, often have thicknesses that range from 2 nm to 10 nm when the underlying aluminum material is an aluminum alloy. Taking into account the thicknesses of the base aluminum substrates 36, 38 and their surface coating(s) 40, if present, the overall thickness of each of the first and second aluminum workpieces 12, 14 preferably ranges of 0.4 mm to 6.0 mm, or more narrowly from 0.5 mm to 3.0 mm, at least within the welding zone 16.

If the first and second base metal substrates 36, 38 are composed of magnesium, each of the base metal substrates 36, 38 (referred to for the moment as the first and second base magnesium substrates 36, 38) may be separately composed of unalloyed magnesium or a magnesium alloy that includes at least 85 wt % magnesium. Some notable magnesium alloys that may constitute the first and/or second base magnesium substrates 36, 38 are a magnesium-zinc alloy, a magnesium-aluminum alloy, a magnesium-aluminum-zinc alloy, a magnesium-aluminum-silicon alloy, and a magnesium-rare earth alloy. Additionally, each of the base magnesium substrates 36, 38 may be separately provided in wrought (sheet, extrusion, forging, or other worked article) or cast form. A few specific examples of magnesium alloys that can be used as the first and/or second base magnesium substrates 36, 38 include, but are not limited to, AZ91D die cast or wrought (extruded or sheet) magnesium alloy, AZ31B die cast or extruded (extruded or sheet) magnesium alloy, and AM60B die cast magnesium alloy. The first and/or second base magnesium substrates 36, 38 may be employed in a variety of tempers including annealed (O), strain hardened (H), and solution heat treated (W).

The surface coating 40 present on one or both of the base magnesium substrates 36, 38 may be a native refractory oxide coating comprised of magnesium oxide compounds (and possibly magnesium hydroxide compounds) that forms passively when fresh magnesium from the base magnesium substrate 36, 38 is exposed to atmospheric air or some other oxygen-containing medium. The surface coating 40 may also be a metallic conversion coating comprised of metal oxides, metal phosphates, or metal chromates. A typical thickness of the surface coating 40, if present, lies anywhere from 1 nm to 10 μm depending on the composition of the coating 40 and the manner in which the coating 40 is derived, although other thicknesses may be employed. Passively formed refractory oxide coatings, for example, often have thicknesses that range from 2 nm to 10 nm when the underlying magnesium material is a magnesium alloy. Taking into account the thicknesses of the base magnesium substrates 36, 38 and their surface coating(s) 40, if present, the overall thickness of each of the first and second magnesium workpieces 12, 14 preferably ranges of 0.4 mm to 6.0 mm, or more narrowly from 0.5 mm to 3.0 mm, at least within the welding zone 16.

FIGS. 1 and 4-5 illustrate an embodiment of the workpiece stack-up 10 that includes two overlapping metal workpieces 12, 14 establishing a single faying interface 34. Of course, as shown in FIG. 6, the workpiece stack-up 10 may include an additional third metal workpiece 150, with a thickness 151, situated between the first and second metal workpieces 12, 14. The third metal workpiece 150, if present, includes a third base metal substrate 152 that may be bare or coated with a surface coating 40 (as shown). The third metal workpiece 150 is similar in many general respects to the first and second metal workpieces 12, 14 and, accordingly, the description of the first and second metal workpieces 12, 14 set forth above (in particular the composition of the base metal substrates, their possible surface coatings, and the workpiece thicknesses) applies fully to the third metal workpiece 150. The welding zone 16 in this embodiment of the workpiece stack-up 10 is now defined by the extent of the common overlap of all of the first, second, and third metal workpieces 12, 14, 150.

As a result of stacking the first, second, and third metal workpieces 12, 14, 150 in overlapping fashion to provide the workpiece stack-up 10, the third metal workpiece 150 has two faying surfaces: a third faying surface 156 and a fourth faying surface 158. The third faying surface 156 overlaps and confronts the first faying surface 28 of the first metal workpiece 12 and the fourth faying surface 158 overlaps and confronts the second faying surface 32 of the second metal workpiece 14. Within the welding zone 16, the confronting first and third faying surfaces 28, 156 of the first and third metal workpieces 12, 150 establish a first faying interface 160 and the confronting second and fourth faying surfaces 32, 158 of the second and third metal workpieces 14, 150 establish a second faying interface 162. These faying interfaces 160, 162 are the same type and encompass the same attributes as the faying interface 34 described above with respect to FIGS. 1 and 3. Consequently, in this embodiment, the exterior outer surfaces 26, 30 of the flanking first and second metal workpieces 12, 14 still face away from each other in opposite directions and constitute the top and bottom surfaces 20, 22 of the workpiece stack-up 10.

Referring back to FIG. 1, the remote laser welding apparatus 18 includes a scanning optic laser head 42. Generally speaking, the scanning optic laser head 42 directs the transmission of the laser beam 24 towards the top surface 20 of the workpiece stack-up 10 (also the exterior outer surface 26 of the first metal workpiece 12). The directed laser beam 24 has a beam spot 44, which, as shown in FIG. 2, is the sectional area of the laser beam 24 at a plane oriented along the top surface 20 of the stack-up 10. The scanning optic laser head 42 is preferably mounted to a robotic arm (not shown) that can quickly and accurately carry the laser head 42 to many different preselected sites around the workpiece stack-up 10 in rapid programmed succession. The laser beam 24 used in conjunction with the scanning optic laser head 42 is preferably a solid-state laser beam operating with a wavelength in the near-infrared range (commonly considered to be 700 nm to 1400 nm) of the electromagnetic spectrum. Additionally, the laser beam 24 has a power level capability that, together with its focal position, can attain a power density sufficient to produce a keyhole, if desired, within the workpiece stack-up 10 during transmission of the laser beam into the workpiece stack-up 10. The power density needed to produce a keyhole within the overlapping metal workpieces 12, 14 (and possibly 150) is typically in the range of 0.5-1.5 MW/cm².

Some examples of a suitable solid-state laser beam that may be used in conjunction with the remote laser welding apparatus 18 include a fiber laser beam, a disk laser beam, and a direct diode laser beam. A preferred fiber laser beam is a diode-pumped laser beam in which the laser gain medium is an optical fiber doped with a rare earth element (e.g., erbium, ytterbium, neodymium, dysprosium, praseodymium, thulium, etc.). A preferred disk laser beam is a diode-pumped laser beam in which the gain medium is a thin laser crystal disk doped with a rare earth element (e.g., a ytterbium-doped yttrium-aluminum garnet (Yb:YAG) crystal coated with a reflective surface) and mounted to a heat sink. And a preferred direct diode laser beam is a combined laser beam (e.g., wavelength combined) derived from multiple diodes in which the gain medium is multiple semiconductors such as those based on aluminum gallium arsenide (AlGaAS) or indium gallium arsenide (InGaAS). Laser generators that can generate each of those types of lasers as well as other variations are commercially available. Other solid-state laser beams not specifically mentioned here may of course be used.

The scanning optic laser head 42 includes an arrangement of mirrors 46 that can maneuver the laser beam 24 and thus convey the beam spot 44 along the top surface 20 of the workpiece stack-up 10—and, as discussed below, along an upper surface of a molten metal portion—within an operating envelope 48 that at least partially spans the welding zone 16. Here, as illustrated in FIG. 1, the portion of the top surface 20 spanned by the operating envelope 48 is labeled the x-y plane since the position of the laser beam 24 within the plane is identified by the “x” and “y” coordinates of a three-dimensional coordinate system. In addition to the arrangement of mirrors 46, the scanning optic laser head 42 also includes a z-axis focal lens 50, which can move a focal point 52 (FIG. 2) of the laser beam 24 along a longitudinal axis 54 of the laser beam 24 to thus vary the location of the focal point 52 in a z-direction, which is oriented perpendicular to the x-y plane in the three-dimensional coordinate system established in FIG. 1. Furthermore, to keep dirt and debris from adversely affecting the optical system components and the integrity of the laser beam 24, a cover slide 56 may be situated below the scanning optic laser head 42. The cover slide 56 protects the arrangement of mirrors 46 and the z-axis focal lens 50 from the surrounding environment yet allows the laser beam 24 to pass out of the scanning optic laser head 42 without substantial disruption.

The arrangement of mirrors 46 and the z-axis focal lens 50 cooperate during operation of the remote laser welding apparatus 18 to dictate the desired movement of the laser beam 24 and its beam spot 44 within the operating envelope 48 as well as the position of the focal point 52 along the longitudinal axis 54 of the beam 24. The arrangement of mirrors 46, more specifically, includes a pair of tiltable scanning mirrors 58. Each of the tiltable scanning mirrors 58 is mounted on a galvanometer 60. The two tiltable scanning mirrors 58 can move the location of the beam spot 44—and thus change the point at which the laser beam 24 impinges the top surface 20 of the workpiece stack-up 10—anywhere in the x-y plane of the operating envelope 48 through precise coordinated tilting movements executed by the galvanometers 60. At the same time, the z-axis focal lens 50 controls the location of the focal point 52 of the laser beam 24 in order to help administer the laser beam 24 at the correct power density and to attain the desired heat input both instantaneously and over time. All of these optical components 50, 58 can be rapidly indexed in a matter of milliseconds or less to advance the beam spot 44 of the laser beam 24 relative to the x-y plane of the top surface 20 of the workpiece stack-up 10 along a beam travel pattern of simple or complex geometry while controlling the location of the focal point 52.

A characteristic that differentiates remote laser welding from other conventional forms of laser welding is the focal length of the laser beam 24. Here, as shown in best in FIG. 1, the laser beam 24 has a focal length 62, which is measured as the distance between the focal point 52 and the last tiltable scanning mirror 58 that intercepts and reflects the laser beam 24 prior to the laser beam 24 exiting the scanning optic laser head 42. The focal length 62 of the laser beam 24 is preferably in the range of 0.4 meters to 2.0 meters with a diameter of the focal point 52 typically ranging anywhere from 100 μm to 700 μm. The focal length, as well as a focal distance 64, can be easily adjusted. The term “focal distance” as used herein refers to the distance between the focal point 52 of the laser beam 24 and the top surface 20 of the workpiece stack-up 10 (or the upper surface of the molten metal portion depending at what point in the disclosed method the focal distance is being referred to) along the longitudinal axis 54 of the laser beam 24, as shown best in FIG. 2, and is typically reported in millimeters. The focal distance 64 of the laser beam 24 is thus zero when the focal point 52 is positioned at the top surface 20 of the stack-up 10.

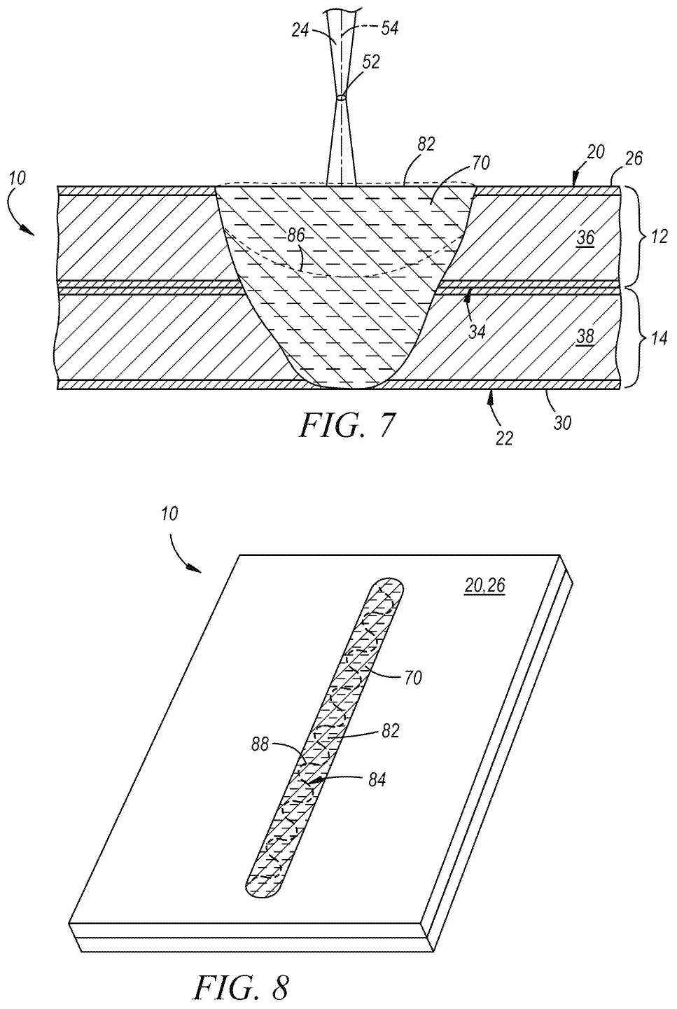

The term “focal position” is related to the focal distance 64 of the laser beam 24 and defines where the focal point 52 is positioned relative to the top surface of the workpiece stack-up. To be sure, when the focal point 52 of the laser beam 24 is positioned at the top surface 20 of the workpiece stack-up 10 or the upper surface of the molten metal portion, as described below with reference to FIGS. 7-9, the focal position of the laser beam 24 is zero (or “0”) and, logically, the focal distance 54 is also zero as noted above. When the focal point 52 of the laser beam 24 is located above the top surface 20 of the workpiece stack-up 10 (or above the upper surface of the molten metal portion), the focal position of the laser beam 24 is the focal distance 54 reported as a positive value (+). Likewise, when the focal point 52 of the laser beam 24 is located below the top surface 20 of the workpiece stack-up 10 (or below the upper surface of the molten metal portion), the focal position of the laser beam 24 is the focal distance 54 reported as a negative value (−). The focal position of the laser beam 24 thus gives an indication of not only the focal distance 54 but also the direction along the longitudinal axis 54 of the laser beam 24 in which the focal point 52 is displaced away from the top surface 20 of the workpiece stack-up 10 (or the upper surface of the molten metal portion).

In the presently disclosed method, and referring for the moment to FIG. 10, a laser weld joint 66 is formed in the workpiece stack-up 10 that autogenously fusion welds each of the metal workpieces 12, 14. The laser weld joint 66 has a top surface 68 that is located adjacent to the surrounding top surface 20 of the workpiece stack-up 10. The top surface 68 of the laser weld joint 66 is rendered smooth as a direct result of practicing the disclose method. In particular, in many implementations of the disclose method, but not necessarily all, the top surface 68 of the laser weld joint 66 has a surface roughness, which is measured as a mean or arithmetic average roughness (Ra), that ranges from 12.5 μm to 0.4 μm. This degree of surface smoothness is, in general, an appreciable improvement over conventional practices in which a molten metal portion is formed by a laser beam and then rapidly solidified, which typically results in a top surface of the resultant laser weld joint having a surface roughness (Ra) that ranges from 200 μm to 13 μm. The roughened or course laser weld joint top surface is especially common when the metal workpieces are composed of aluminum or magnesium.

The laser weld joint 66 shown here in FIG. 10 is depicted for illustrative purposes in a “2T” stack-up similar to that shown in FIGS. 1 and 4-5 in which the workpiece stack-up 10 includes only the first and second metal workpieces 12, 14. The same basic laser weld joint structure could also be attained in a “3T” stack-up similar to that shown in FIG. 6 that includes the first, second, and third metal workpieces 12, 14, 150 even though a depiction of such a laser weld joint is not explicitly illustrated. The following description of the laser weld joint 66 can thus be easily translated to embodiments of the disclosed method in which the workpiece stack-up 10 is a “3T” stack-up that includes the first, second, and third metal workpieces 12, 14, 150 and even a “4T” stack-up that would include two additional metal workpieces situated between the flanking first and second metal workpieces 12, 14. However, for clarity and ease of discussion, the laser weld joint 66 is discussed below in the context of the “2T” workpiece stack-up embodiment with the understanding that the disclosed method is not necessarily limited to that embodiment.

The presently disclosed method generally begins by providing the workpiece stack-up 10 which, typically, involves assembling the individual first and second metal workpieces 12, 14 (plus any additional metal workpieces such as the third metal workpiece 150) into the stack-up 10 by aligning and fitting the metal workpieces 12, 14 together with suitable fixturing and/or clamping equipment to provide the welding zone 16. Once the workpiece stack-up 10 has been provided, the laser weld joint 66 is formed within the welding zone 16 preferably by operation of the remote laser welding apparatus 18. At least two stages of laser beam action are performed and controlled by the remote laser welding apparatus 18 during formation of the laser weld joint 66. First, as shown in FIGS. 3-5, a molten metal portion 70 is created within the workpiece stack-up 10 by the laser beam 24. After the molten metal portion 70 is created, the laser beam 24 undergoes a reduction in power density and is used to introduce heat into the molten metal portion 70 to prevent full solidification of the molten metal portion 70, as shown in FIGS. 7-9. The active effort to delay full solidification of the molten metal portion 70 is what allows the laser weld joint 66 to realize a smooth top surface 68.

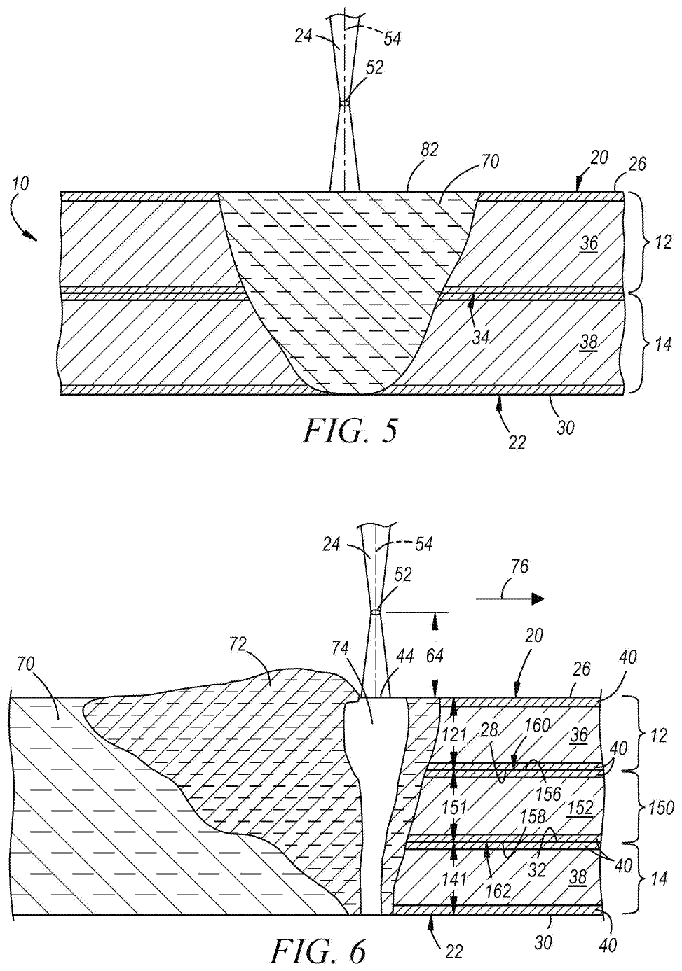

Referring now specifically to FIGS. 3-5, the molten metal portion 70 (FIG. 5) is created in the workpiece stack-up 10 by melting a part of the workpiece stack-up 10 with the laser beam 24. To do so, the laser beam 24 is directed by the scanning optic laser head 42 at top surface 20 of the workpiece stack-up at a predetermined site within the welding zone 16. The resultant impingement of the top surface 20 of the stack-up 10 by the laser beam 24 originates a molten metal weld pool 72 within the stack-up 10 that penetrates into the stack-up 10 from the top surface 20 towards the bottom surface 22 and that intersects at least one faying interface. For instance, in the 2T stack-up shown in FIGS. 1 and 4-5, the molten metal weld pool 72 intersects the faying interface 34 established between the metal workpieces 12, 14 and may fully or partially penetrate the workpiece stack-up 10. Similarly, in the 3T stack-up shown in FIG. 6, the molten metal weld pool 72 intersects at least the first faying interface 160, and in many instances both of the first and second faying interfaces 160, 162, and may fully or partially penetrate the workpiece stack-up 10. The molten metal weld pool 72 produced by the laser beam 24 is the volume of molten metal within the workpiece stack-up 10 beneath and/or surrounding the beam spot 44 of the laser beam 24 that can persist in a molten state so long as the laser beam 24 is being transmitted to the workpiece stack-up 10 due to the absorption of laser beam energy.

The laser beam 24, moreover, preferably has a power density sufficient to vaporize the workpiece stack-up 10 directly beneath the beam spot 44. This vaporizing action produces a keyhole 74, also depicted in FIGS. 3-4, which is a column of vaporized workpiece metal that oftentimes contains plasma. The keyhole 74 is formed within the molten metal weld pool 72 and exerts an outwardly-directed vapor pressure sufficient to prevent the surrounding molten metal weld pool 72 from collapsing inward. And, like the molten metal weld pool 72, the keyhole 74 also penetrates into the workpiece stack-up 10 from the top surface 20 towards the bottom surface 22 and intersects the faying interface 34 (or the first and/or second faying interfaces 160, 162) established between the first and second metal workpieces 12, 14 (or the first, second, and third metal workpieces 12, 150, 14). The keyhole 74 provides a conduit for the laser beam 24 to deliver energy down into the workpiece stack-up 10, thus facilitating relatively deep and narrow penetration of the molten metal weld pool 72 into the workpiece stack-up 10 accompanied by a relatively small surrounding heat-affected zone (HAZ). The keyhole 74 may fully (as shown) or partially penetrate the workpiece stack-up 10 along with the molten metal weld pool 72.

Upon creating the molten metal weld pool 72 and preferably the keyhole 74—i.e., keyhole or deep penetration welding mode—the beam spot 44 of the laser beam 24 is advanced in a forward direction 76 relative to the top surface 20 of the workpiece stack-up 10 in the x-y plane of the operating envelope 48 along a primary beam travel pattern 78, as shown best in FIG. 3. The primary beam travel pattern 78 may include one or more weld paths 80 as projected onto the top surface 20 such as, for example, a single spiral weld path arranged in an Archimedean or non-Archimedean spiral, a series of radially-spaced concentric circular or elliptical weld paths, a single sinusoidal or other periodic or undulating weld path, a single linear weld path, a single staple or “C” shaped weld path, or any other suitable pattern of one or more weld paths. Some specific examples of several of the previously mentioned beam travel patterns plus others that may be useful as the primary beam travel pattern 78 are shown and described in PCT/CN2016/106914, PCT/CN2016/102669, PCT/CN2016/083112, PCT/CN2015/094003, PCT/CN2015/088569, and PCT/CN2015/088563, to name but a few possibilities, all of which are incorporated herein by reference in their entireties. The primary beam travel pattern 78 shown here in FIG. 3 for illustrative purposes comprises a single spiral weld path arranged in an Archimedean spiral.

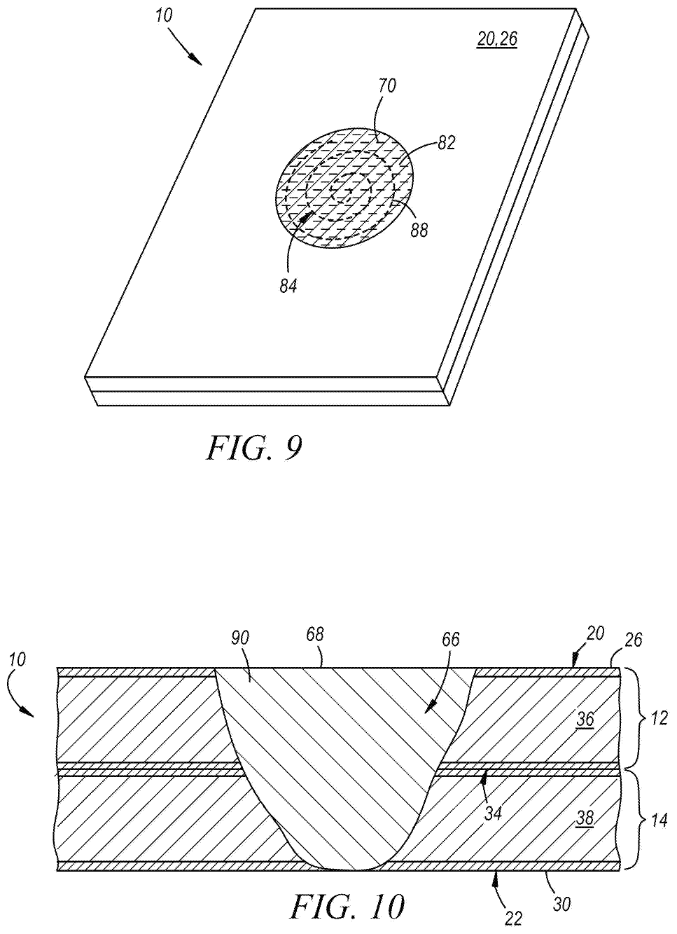

The advancement of the beam spot 44 of the laser beam 24 along the primary beam travel pattern 78 is managed by precisely controlling the coordinated movements of the tiltable scanning mirrors 58 within the scanning optic laser head 42. As the beam spot 44 of the laser beam 24 is being advanced along the primary beam travel pattern 78, the molten metal weld pool 72 (along with the keyhole 74, if present) is translated along a corresponding route within the workpiece stack-up 10. This causes penetrating molten metal to flow around and behind the beam spot 44 and the molten weld pool 72 within the workpiece stack-up 10, resulting in the growth of the molten metal portion 70 in the wake of the advancing progression of the laser beam 24. And, depending on the geometry of the primary beam travel pattern 78, the molten metal portion 70 may constitute a discrete elongated molten trail behind the forward advancement of the beam spot 44 of the laser beam 24, as depicted in FIG. 8, or it may a consolidated melt puddle that results from the merger of molten material when the beam spot 44 of the laser beam 24 is advanced along multiple portions of the same weld path or multiple discrete weld paths that are in close proximity, as depicted in FIG. 9.

The molten metal portion 70 is thus constitutes the full volumetric collection of molten material produced by advancement of the beam spot 44 of the laser beam 24 along the primary beam travel pattern 78 and is comprised of material from each of the metal workpieces 12, 14 (or 12, 150, 14) melted by the laser beam 24. As shown best in FIG. 5, the molten metal portion 70, which is depicted in the form of a consolidated melt puddle, includes an upper surface 82 exposed alongside the top surface 20 of the workpiece stack-up 10. And in much the same way as the molten metal weld pool 72 in the immediate vicinity of the beam spot 44 of the laser beam 24, the molten metal portion 70 penetrates into the workpiece stack-up 10 from the top surface 20 of the stack-up 10 towards the bottom surface 22 of the stack-up 10 and intersects each faying interface 34 (or 160, 162) established within the workpiece stack-up 10 between its top and bottom surfaces 20, 22. In that regard, the molten metal portion 70 may fully or partially penetrate the workpiece stack-up 10. A fully penetrating molten metal portion 70 penetrates entirely through the workpiece stack-up 10 and breaches the bottom surface 22, as shown, while a partially penetrating molten metal portion 70 penetrates into the second metal workpiece 14 to some intermediate depth and therefore does not breach the bottom surface 22 of the workpiece stack-up 10.

To create the molten metal portion 70, the laser beam 24 must have a power density sufficient to melt the individual metal workpieces 12, 14 (or 12, 150, 14) included in the workpiece stack-up 10 and, if desired, to produce the keyhole 74 within the stack-up 10 beneath the beam spot 44 of the laser beam 24. The power density of the laser beam 24 is simply the power level of the laser beam 24 divided by the projected area of the beam spot 44 of the laser beam, and is often reported in kW/cm² or MW/cm². To that end, the power density of the laser beam 24 is dependent on the power level of the laser beam 24 and, particularly if the laser beam 24 is a Gaussian beam, the focal distance 64 of the laser beam 24, and may range anywhere from 0.7 MW/cm² to 4.0 MW/cm² when the laser beam 24 is being advanced along the primary beam travel pattern 78. In addition to power density, the travel speed of the laser beam 24 can be managed to control the energy absorption and melting efficiency of the laser beam 24 in order to create the desired molten metal portion 70. In many embodiments of the disclosed method, the molten metal portion 70 can be created by advancing the laser beam 24 relative to the top surface 20 of the workpiece 10 along the primary beam travel pattern 78 at a travel speed that ranges from 1 m/min to 120 m/min while the power level of the laser beam 24 ranges from 2 kW to 10 kW and the focal position of the laser beam 24 is between −20 mm and +20 mm.

Following creating, the upper surface 82 of the molten metal portion 70 has a tendency to be disturbed and to develop micro-bumps and other surface anomalies if the transmission of laser beam 24 beam is ceased and the molten metal portion 70 is allowed to rapidly cool. An overly roughened or coarse top surface of the resultant laser weld joint can have several adverse effects on the visual appearance and/or the structural integrity of the weld joint. To address this issue, the disclosed method calls for reducing the power density of the laser beam 24 and moving the beam spot 44 of the laser beam 34 relative to the upper surface 80 of the molten metal portion 70 in the x-y plane of the operating envelope 48 along a secondary beam travel pattern 84, as shown in FIGS. 7-9. The movement of the beam spot 44 of the laser beam 24 along the secondary beam travel pattern 84 in a reduced power density state introduces heat into the molten metal portion 70 and prevents the molten metal portion 70 from fully solidifying. More specifically, at least an upper region 86 of the molten metal portion 70 that includes the upper surface 82 of the molten metal portion 70 is maintained in a molten state, as illustrated in FIG. 7. The upper region 86 of the molten metal portion 70 that remains in a molten state should constitute no less than 10% of the volume of the originally-created molten metal portion 70 while, preferably, the entire molten metal portion 70 is retained in a molten state.

The reduction in the power density of the laser beam 24 and the movement of the beam spot 44 of the laser beam 24 along the secondary beam travel pattern 84 may be controlled and implemented by the remote laser welding apparatus 18 immediately after the molten metal portion 70 has been created. To reduce the power density of the laser beam 44, for example, one of the following may be carried out: (1) defocusing the laser beam 24 to increase the focal distance 64 of the laser beam 24; (2) reducing the power level of the laser beam 24; or (3) defocusing the laser beam 24 to increase the focal distance 64 of the laser beam 24 and reducing the power level of the laser beam 24. It should be noted that the laser beam 24 can be defocused by moving the focal point 52 of the laser beam 24 away from the top surface 20 of the workpiece stack-up 10 along the longitudinal axis 54 of the laser beam 24 such that the focal point 52 assumes a more positive (+) focal position or a more negative (−) focal position. In either instance, as the focal point 52 of the laser beam moves away from the top surface 20 of the workpiece stack-up 10, the surface area of the beam spot 44 will increase provided that the laser beam 24 has a Gaussian intensity distribution or some other applicable intensity profile.

The power density of the laser beam 24 is preferably reduced so that it ranges anywhere from 0.01 MW/cm² to 0.5 MW/cm² when the laser beam 24 is being moved along the secondary beam travel pattern 84. As for the travel speed of the laser beam 24, it can be increased, decreased, or kept the same depending on a variety of factors including the size and shape of the molten metal portion 70, the geometry of the secondary beam travel pattern 84, the composition of the metal workpieces 12, 14 (or 12, 150, 14), and the extent of the power density reduction, to name but a few. In many embodiments of the disclosed method, the laser beam 24 may be moved relative to the upper surface 82 of the molten metal portion 70 along the secondary beam travel pattern 84 at a travel speed that ranges from 10 m/min to 120 m/min while the power level of the laser beam 24 ranges from 2 kW to 10 kW and the focal position of the laser beam 24 is between −50 mm and −10 mm or +10 mm and +50 mm. Of course, other combinations of these laser beam parameters that fall outside of one or more of the aforementioned ranges may certainly be possible under certain circumstances of the disclosed method.

The movement of the beam spot 44 of the laser beam 24 along the secondary beam travel pattern 84 may be performed by precisely controlling the coordinated movements of the tiltable scanning mirrors 58 within the scanning optic laser head 42 similar to before when tracing the primary beam travel pattern 78. The laser beam travel patter 84 may include one or more weld paths 88 as projected onto the upper surface 82 of the molten metal portion 70 such as, for example, a single spiral weld path arranged in an Archimedean or non-Archimedean spiral, a series of radially-spaced concentric circular or elliptical weld paths, a sinusoidal or other periodic weld path, a single linear weld path, a single staple or “C” shaped weld path, or any other suitable pattern of one or more weld paths. Accordingly, the secondary beam travel pattern 84 may be the same as, of different from, the primary beam travel pattern 78, and it may be any of the beam travel patterns shown and described in the International patent applications referred to above with respect to the primary beam travel pattern 78 and incorporated herein by reference. For example, the secondary beam travel pattern 78 may be a single spiral weld path arranged in an Archimedean spiral, as shown in FIG. 8, or it may be a single sinusoidal weld path as shown in FIG. 9. Moreover, the secondary beam travel pattern 84 may be commensurate in area with the upper surface 82 of the molten metal portion 70, as shown in FIGS. 8-9, although such a relationship is not necessarily required as the secondary beam travel pattern 84 can be larger or smaller in area than the upper surface 82 of the molten metal portion 70.

Because the laser beam 24 has a reduced power density when being moved along the secondary beam travel pattern 84, and a keyhole is not present beneath the beam spot 44, the amount of heat introduced into the molten metal portion 70 is not sufficient to agitate and further grow the molten metal portion 70. Rather, as indicated above, the effect of such laser beam maneuvering is to introduce heat into the molten metal portion 70 to maintain at least the upper region 86 in a molten state. Under these circumstances, energy is redistributed along the upper surface 82 of the molten metal portion 70 and enough time is provided for the inherent surface tension of the molten metal to naturally cause the upper surface 82 to settle and flatten out. And while the exact amount of time needed for the flattening out of the upper surface 82 of the molten metal portion 70 can vary based on several factors, keeping at least the upper region 86 of the molten metal portion 70—and preferably the entire molten metal portion 70—in a molten state for a period of 50 ms to 1000 ms on account of the heat input from the laser beam 24 as it traces the secondary beam travel pattern 84 is sufficient in many instances.

Once the beam spot 44 of the laser beam 24 finishes tracing the secondary beam travel pattern 84, the laser beam 24 is removed from the upper surface 82 of the molten metal portion 70, typically by ceasing transmission of the laser beam 24. The removal of the laser beam 24 from the molten metal portion 70 causes the molten metal portion 70 with its now settled and flattened out upper surface 82 to quickly cool and solidify into resolidified composite workpiece material 90, as shown in FIG. 10. The resolidified composite workpiece material 90 is derived from each of the metal workpieces 12, 14 (or 12, 150, 14) penetrated by the molten metal portion 70 and its composition is determined by the compositions of the penetrated metal workpieces. The collective resolidified composite workpiece material 90 obtained from the laser beam 24 constitutes the laser weld joint 66 and the smooth top surface 68 of the joint 66 is obtained from the solidification of the upper surface 82 of the molten metal portion. Consequently, and as shown in FIG. 10, the laser weld joint 66 extends into the workpiece stack-up 10 from the top surface 20 of the stack-up 10 towards the bottom surface 22 while intersecting each established faying interface 34 (or 160, 162) and, furthermore, may extend fully through or partially into the workpiece stack-up 10 depending on the extent to which the molten metal portion 70 penetrated the stack-up 10 during transmission of the laser beam 24.

The laser weld joint 66 can assume a variety of shapes and structures depending on the geometry of the primary beam travel pattern 78. For example, the laser weld joint 66 may be constructed as a laser spot weld joint, which is a consolidated nugget of resolidified composite workpiece material 90 that may be formed by maneuvering the laser beam 24 along a primary beam travel pattern comprised of a spiral weld path or a series of concentric circular or elliptical weld paths such that the molten metal portion 70 essentially grows into a larger consolidated melt puddle such as the one shown representatively in FIG. 9. In another example, the laser weld joint 66 may be constructed as a laser seam weld joint, which is a trail of resolidified composite workpiece material 90 formed by maneuvering the laser beam 24 along a primary beam travel pattern comprised of a linear weld path, a nonlinear weld path such as a C-shaped “staple” or undulating weld path, or a single circular or elliptical weld path having a large enough diameter that a central non-welded portion exists such that the molten metal portion 70 constitutes a discrete elongated molten trail such as the one representatively shown in FIG. 8. Regardless of its final shape and structure, the resolidified composite metal workpiece material 90 of the laser weld joint 66 autogenously fusion welds the metal workpieces 12, 14 (or 12, 150, 14) together while the top surface 68 of the weld joint 66 has a consistent smoothness on account of practicing the disclosed method with its at least two stages of laser beam action.

The above description of preferred exemplary embodiments and specific examples are merely descriptive in nature; they are not intended to limit the scope of the claims that follow. Each of the terms used in the appended claims should be given its ordinary and customary meaning unless specifically and unambiguously stated otherwise in the specification.

1. A method of joining together metal workpieces by the practice of laser welding, the method comprising:
assembling a workpiece stack-up that includes two or more metal workpieces that overlap to define a welding zone, the welding zone of the workpiece stack-up having a top surface and a bottom surface and further establishing a faying interface between each pair of adjacent metal workpieces included in the workpiece stack-up;
advancing a beam spot of a laser beam relative to the top surface of the workpiece stack-up along a primary beam travel pattern to create a molten metal portion that penetrates into the workpiece stack-up from the top surface of the stack-up towards the bottom surface of the stack-up and intersects the at least one faying interface established between the top and bottom surfaces of the workpiece stack-up;
reducing a power density of the laser beam after creation of the molten metal portion and moving the beam spot of the laser beam relative to an upper surface of the molten metal portion along a secondary beam travel pattern to introduce heat into the molten metal portion such that the molten metal portion is prevented from fully solidifying and at least an upper region of the molten metal portion that includes the upper surface is maintained in a molten state; and
removing the laser beam from the molten metal portion to allow the molten metal portion to solidify into a laser weld joint comprised of resolidified composite workpiece material derived from each of the metal workpieces penetrated by the molten metal portion.

2. The method set forth in claim 1, wherein the workpiece stack-up includes two or three overlapping metal workpieces.

3. The method set forth in claim 2, wherein each of the two or three overlapping metal workpieces is a steel workpiece.

4. The method set forth in claim 2, wherein each of the two or three overlapping metal workpieces is an aluminum workpiece or a magnesium workpiece.

5. The method set forth in claim 1, wherein the laser weld joint is a laser spot weld joint.

6. The method set forth in claim 1, wherein the laser weld joint is a laser seam weld joint.

7. The method set forth in claim 1, wherein the laser weld joint has a top surface adjacent to the top surface of the workpiece stack-up, and wherein the top surface of the laser weld joint has a surface roughness (Ra) that ranges from 12.5 μm to 0.4 μm.

8. The method set forth in claim 1, wherein the laser beam is a solid-state laser beam, and wherein advancing the laser beam along the primary beam travel pattern to create the molten metal portion and then moving the laser beam along the secondary beam travel pattern to introduce heat into the molten metal portion is performed by a remote laser welding apparatus.

9. The method set forth in claim 8, wherein the laser beam is advanced relative to the top surface of the workpiece along the primary beam travel pattern at a travel speed that ranges from 1 m/min to 120 m/min while a power level of the laser beam ranges from 2 kW to 10 kW and a focal position of the laser beam is between −20 mm to +20 mm.

10. The method set forth in claim 8, wherein the laser beam is moved relative to the upper surface of the molten metal portion along the secondary beam travel pattern at a travel speed that ranges from 10 m/min to 120 m/min while a power level of the laser beam ranges from 2 kW to 10 kW and a focal position of the laser beam is between −50 mm and −10 mm or +10 mm and +50 mm.

11. The method set forth in claim 1, wherein reducing the power density of the laser beam comprises defocusing the laser beam to increase a focal distance of the laser beam, reducing a power level of the laser beam, or defocusing the laser beam to increase a focal distance of the laser beam and reducing a power level of the laser beam.

12. The method set forth in claim 1, wherein a keyhole is produced beneath the beam spot of the laser beam and is translated within the workpiece stack-up during advancement of the beam spot of the laser beam along the primary beam travel pattern.

13. A method of joining together metal workpieces by the practice of laser welding, the method comprising:
providing a workpiece stack-up that includes two or more metal workpieces that overlap to define a welding zone, the welding zone of the workpiece stack-up having a top surface and a bottom surface and further establishing a faying interface between each pair of adjacent metal workpieces included in the workpiece stack-up, and wherein all of the two or more metal workpieces in the workpiece stack-up are steel workpieces, aluminum workpieces, or magnesium workpieces;
directing a laser beam at the top surface of the workpiece stack-up to produce a keyhole within the workpiece stack-up that is surrounded by a molten metal weld pool, the laser beam having a power density;
advancing a beam spot of the laser beam relative to the top surface of the workpiece stack-up along a primary beam travel pattern to create a molten metal portion that penetrates into the workpiece stack-up from the top surface of the stack-up towards the bottom surface of the stack-up and intersects the at least one faying interface established between the top and bottom surfaces of the workpiece stack-up, wherein the power density of the laser beam ranges from 0.7 MW/cm² to 4.0 MW/cm² during advancement of the laser beam along the primary beam travel pattern;
reducing the power density of the layer beam after creation of the molten metal portion to between 0.01 MW/cm² and 0.5 MW/cm²;
moving the beam spot of the laser beam relative to an upper surface of the molten metal portion along a secondary beam travel pattern to introduce heat into the molten metal portion such that the molten metal portion is prevented from fully solidifying and at least an upper region of the molten metal portion that includes the upper surface is maintained in a molten state; and
ceasing transmission of the laser beam to allow the molten metal portion to fully solidify into a laser weld joint comprised of resolidified composite workpiece material derived from each of the metal workpieces penetrated by the molten metal portion.

14. The method set forth in claim 13, wherein the workpiece stack-up includes two or three overlapping metal workpieces.

15. The method set forth in claim 13, wherein the laser weld joint has a top surface adjacent to the top surface of the workpiece stack-up, and wherein the top surface of the laser weld joint has a surface roughness (Ra) that ranges from 12.5 μm to 0.4 μm.

16. The method set forth in claim 13, wherein reducing the power density of the laser beam comprises defocusing the laser beam to increase a focal distance of the laser beam, reducing a power level of the laser beam, or defocusing the laser beam to increase a focal distance of the laser beam and reducing a power level of the laser beam.

17. The method set forth in claim 13, wherein the laser beam is a solid-state laser beam, wherein advancing the laser beam along the primary beam travel pattern to create the molten metal portion and then moving the laser beam along the secondary beam travel pattern to introduce heat into the molten metal portion is performed by a remote laser welding apparatus which controls a power level, travel speed, and focal position of the laser beam, wherein the laser beam is advanced relative to the top surface of the workpiece along the primary beam travel pattern with the travel speed ranging from 1 m/min to 120 m/min while the power level of the laser beam ranges from 2 kW to 10 kW and the focal position of the laser beam is between −20 mm to +20 mm, and wherein the laser beam is moved relative to the upper surface of the molten metal portion along the secondary beam travel pattern with the travel speed ranging from 10 m/min to 120 m/min while the power level of the laser beam ranges from 2 kW to 10 kW and the focal position of the laser beam is between −50 mm and −10 mm or +10 mm and +50 mm.

18. A method of joining together metal workpieces by the practice of laser welding, the method comprising:
providing a workpiece stack-up that includes two or more metal workpieces that overlap to define a welding zone, the welding zone of the workpiece stack-up having a top surface and a bottom surface and further establishing a faying interface between each pair of adjacent metal workpieces included in the workpiece stack-up, and wherein all of the two or more metal workpieces in the workpiece stack-up are steel workpieces, aluminum workpieces, or magnesium workpieces;
operating a scanning optic laser head of a remote laser welding apparatus to direct a laser beam at the top surface of the workpiece stack-up and, additionally, to advance a beam spot of the laser beam relative to the top surface of the workpiece stack-up within the welding zone and along a primary beam travel pattern to translate a keyhole along a corresponding route within the workpiece stack-up, thereby creating a molten metal portion that penetrates into the workpiece stack-up and intersects each faying interface established between the top and bottom surfaces of the workpiece stack-up;
operating the scanning optic laser head of the remote laser welding apparatus to reduce a power density of the laser beam and to further move the beam spot of the laser beam relative to an upper surface of the molten metal portion along a secondary beam travel pattern to introduce heat into the molten metal portion such that at least an upper region of the molten metal portion that includes the upper surface is maintained in a molten state; and
removing the laser beam from the molten metal portion to allow the molten metal portion to solidify into a weld joint that fusion welds the two or three metal workpieces together, the laser weld joint having a smooth top surface adjacent to the top surface of the workpiece stack-up that has a surface roughness (Ra) that ranges from 12.5 μm to 0.4 μm.

19. The method set forth in claim 18, wherein reducing the power density of the laser beam comprises defocusing the laser beam to increase a focal distance of the laser beam, reducing a power level of the laser beam, or defocusing the laser beam to increase a focal distance of the laser beam and reducing a power level of the laser beam.

20. The method set forth in claim 18, wherein the laser beam is moved relative to the upper surface of the molten metal portion along the secondary beam travel pattern with the travel speed ranging from 10 m/min to 120 m/min while the power level of the laser beam ranges from 2 kW to 10 kW and the focal position of the laser beam is between −50 mm and −10 mm or +10 mm and +50 mm.
